(19) United States
(12) Patent Application Publication
(10) Pub. No.: US 2025/0187875 A1
(43) Pub. Date: Jun. 12, 2025

(54) SAFETY APPARATUS FOR AN ELEVATOR

(71) Applicant: CEDES AG, Landquart (CH)

(72) Inventor: Bernd KAGERER, Duesseldorf (DE)

(73) Assignee: CEDES AG, Landquart (CH)

(21) Appl. No.: 18/967,749

(22) Filed: Dec. 4, 2024

(30) Foreign Application Priority Data
Dec. 11, 2023 (EP) 23 215 574.7

(51) Int. Cl. B66B 5/02; B66B 1/34

(52) U.S. Cl. CPC B66B 5/02; B66B 1/3461

(57) ABSTRACT

Safety apparatus having a presence determination device for determining a person in an elevator car, a stopped state determination device for determining the stopped state of the elevator car, a door state determination device for determining the closed state and the duration of the closed state of the car door of the elevator car, and a relay device for relaying a signal to a supervisory authority. The relay device relays the signal when the door state determination device determines the closed state for the car door, the presence determination device determines a person in the elevator car, and the stopped state determination device determines the stopped state of the elevator car and a specific length of time has elapsed since the stopped state determination device has continuously determined the stopped state of the elevator car.

This application claims the benefit under 35 USC § 119 (a)-(d) of European Application No. 23 215 574.7 filed Dec. 11, 2023, the entirety of which is incorporated herein by reference.

### FIELD OF THE INVENTION

The present invention relates to a safety apparatus for elevators for when persons are inadvertently trapped in the elevator car.

### BACKGROUND OF THE INVENTION

The prior art discloses safety apparatuses of the type mentioned that provide an alarm button in the elevator car for when persons are inadvertently trapped in the elevator car.

The object of the present invention is to provide an improved safety apparatus of the stated type.

The safety apparatus according to the present invention is a safety apparatus for an elevator having an elevator car having a car door, having a presence determination device for determining a presence of at least one person in the elevator car, having a stopped state determination device for determining the stopped state of the elevator car, having a door state determination device for determining the closed state and the duration of the closed state of the car door of the elevator car, and having a relay device for relaying a signal to a supervisory authority. In this case, the relay device is designed to relay the signal when the door state determination device determines the closed state for the car door and the presence determination device determines at least one person in the elevator car and the stopped state determination device determines the stopped state of the elevator car and a specific length of time has elapsed since the stopped state determination device has continuously determined the stopped state of the elevator car and the door state determination device has continuously determined the closed state of the car door.

The safety apparatus can afford the advantage that passenger safety is increased and/or an automated alert is provided, and/or that misuse is prevented, thereby allowing costs to be saved.

The presence determination device, the stopped state determination device and/or the door state determination device may be designed to transmit a signal containing the result of their determinations to the relay device.

Determination may be a measurement, or detection, or a signal state, or the reception of a corresponding signal.

The presence determination device can be a 2D or 3D camera in the elevator car that monitors the space in the elevator car and that has an image recognition system that identifies persons and the number of persons. The presence determination device can be a 2D or 3D camera that monitors the entrance to the elevator car and identifies persons and their direction of movement into or out of the elevator cars and that uses the directions of movement to calculate the number of persons in the elevator. The presence determination device can be a system that uses an accelerometer to measure the horizontal movement of the car when a person gets into or leaves the elevator car and that uses the number of entrances and exits to calculate the number of persons in the elevator car. The presence determination device can be a system comprising two light barriers, positioned in the doorway of the entrance to the elevator car one behind the other in the direction of passage, that detects the direction of movement of a person's entrance or exit into or out of the elevator car by virtue of the time offset of detection and that uses the entrance or exit count to determine the number of persons in the elevator car.

The stopped state determination device can be an absolute position determination system that detects the position of the elevator car and ascertains the speed or the stopped state therefrom. The stopped state determination device can be the general control device for the traveling movement of the elevator, which can indicate the stopped state. The stopped state determination device can be a holding brake that, by virtue of its status, forces the stopped state of the elevator car. The stopped state determination device can be an acceleration sensor on the elevator car that detects the movement state of the elevator car.

The door state determination device can comprise a contact switch on the elevator car for detecting the closed state. The door state determination device can be the general control device for the traveling movement of the elevator, which can indicate the door state.

The relay device can be a wired or wireless relay device.

The supervisory authority can be a service company for continuous monitoring of the elevator.

The safety apparatus preferably comprises a knock detection device for determining a knock on the car door. The relay device is preferably designed to relay the signal when knocking has been recorded by the apparatus for sensing mechanical or acoustic vibrations during the specific length of time.

This can afford the advantage that the reliability of the safety apparatus is further increased by linking automatic and manual elements that verify one another.

The knock detection device preferably comprises a vibration sensor for detecting the vibration or a microphone for detecting the noises of the cabin door. The knock detection device preferably comprises an evaluation device that determines knocking depending on the strength of the vibration or the volume of the noise and/or the repetition of a specific strength or volume.

The safety apparatus preferably comprises a timer for determining the length of time.

The relay device preferably comprises a connection to a server that is physically separate from the elevator, in particular, a wireless connection, in particular, an Internet connection.

This can afford the advantage that the signal of the safety apparatus in accordance with the Internet of things can be processed in a physically separate server and can be made known worldwide via a browser.

Further features of the present invention are indicated in the drawings.

The advantages mentioned in each case may also be achieved for combinations of features in connection with which they are not mentioned.

### BRIEF DESCRIPTION OF THE DRAWINGS

Exemplary embodiments of the present invention are illustrated in the drawings and are explained in more detail below. The same reference signs in the individual figures in this case denote elements that correspond to one another.

FIG. 1 shows a flowchart for the safety apparatus.

FIG. 2 shows an extended flowchart for the safety apparatus.

### DETAILED DESCRIPTION OF THE INVENTION

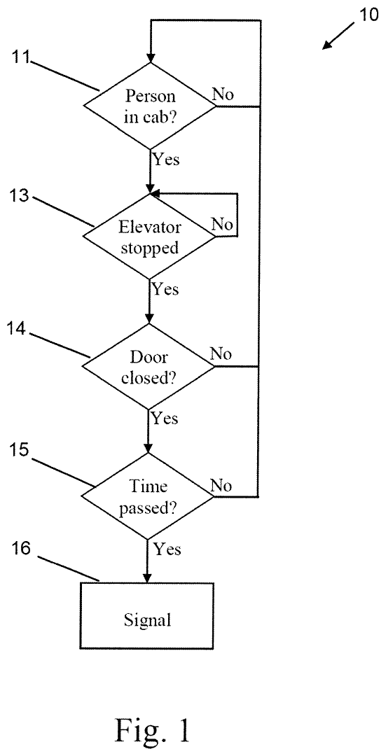

FIG. 1 shows a flowchart for the safety apparatus 10. The sequence starts at the presence determination device 11.

The presence determination device determines whether there is at least one person in the elevator car. If there are no persons in the elevator car, the sequence begins with the presence determination device 11 again. If the presence determination device detects at least one person in the elevator car, however, the sequence moves on to the stopped state determination device 13.

The stopped state determination device 13 determines whether the elevator car is in the stopped state. If the stopped state determination device detects that the elevator car is traveling, the sequence returns to the stopped state determination device until the elevator stops. If the stopped state determination device now detects that the elevator has stopped, however, the sequence moves on to the door state determination device 14.

The door state determination device 14 determines whether the elevator door of the elevator car is closed. If the door state determination device detects that the elevator door is not closed, the sequence begins with the presence determination device 11 again. If the door state determination device detects that the elevator door is closed, however, the sequence moves on to the transmission device 15.

The transmission device 15 uses a timer to determine whether a specific length of time has elapsed since the time at which it was detected that the elevator car was stopped and that the car door was in the closed state at the same time. To this end, the transmission device stores the time from which the stopped state determination device and the door state determination device detect at the same time. As long as the length of time has not elapsed, the sequence begins with the presence determination device 11 again. As soon as the length of time during which the elevator was continually stopped and the doors were closed has elapsed, the transmission device sends the signal 16 wirelessly via the Internet to a server.

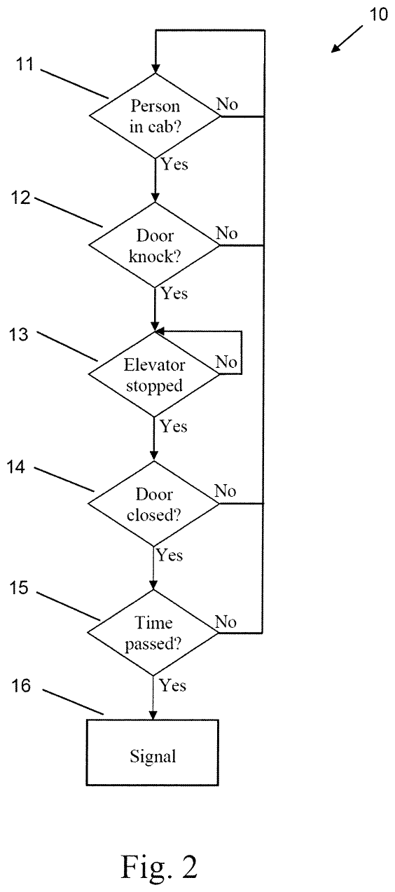

FIG. 2 shows a flowchart for the safety apparatus 10 as in FIG. 1, but this is extended by a knock detection device.

The function of the presence determination device 11 is as described for FIG. 1.

However, in contrast to FIG. 1, here, if it detects at least one person in the elevator car, the flow of the presence determination device 11 continues to the knock detection device 12.

The knock detection device 12 uses a vibration sensor to determine whether there is a knock on the car door. If the knock detection device does not detect that there is a knock on the car door, the sequence begins with the presence determination device 11 again. However, if the knock detection device does detect that there is a knock on the car door, the flow continues to the stopped state determination device 13.

The rest of the process is as described for FIG. 1.

### LIST OF REFERENCE SIGNS

10 Flowchart for the safety apparatus
11 Presence determination device
12 Knock detection device
13 Stopped state determination device
14 Door state determination device
15 Relay device
16 Signal for alarm

1-5. (canceled)

6. A safety apparatus for an elevator having an elevator car having a car door,
comprising a presence determination device for determining a presence of at least one person in the elevator car, a stopped state determination device for determining the stopped state of the elevator car, a door state determination device for determining the closed state and the duration of the closed state of the car door of the elevator car, and a relay device for relaying a signal to a supervisory authority,
wherein the relay device is designed to relay the signal when the door state determination device determines the closed state for the car door and the presence determination device determines at least one person in the elevator car and the stopped state determination device determines the stopped state of the elevator car and a specific length of time has elapsed since the stopped state determination device has continuously determined the stopped state of the elevator car and the door state determination device has continuously determined the closed state of the car door.

7. The safety apparatus according to claim 6, wherein the safety apparatus comprises a knock detection device for determining knocking on the cabin door, and the relay device is designed to relay the signal when knocking has been recorded by the apparatus for sensing mechanical or acoustic vibrations during the specific length of time.

8. The safety apparatus according to claim 7, wherein the knock detection device comprises a vibration sensor for detecting the vibration or a microphone for detecting the noises of the cabin door and comprises an evaluation device that determines knocking depending on the strength of the vibration or the volume of the noise and/or the repetition of a specific strength or volume.

9. The safety apparatus according to claim 6, wherein the safety apparatus comprises a timer for determining the length of time.

10. The safety apparatus according to claim 6, wherein the relay device comprises a connection to a server that is physically separate from the elevator, in particular a wireless connection, in particular an Internet connection.
